(19) United States
(12) Patent Application Publication
(10) Pub. No.: US 2010/0096215 A1
(43) Pub. Date: Apr. 22, 2010

(54) LADDER ASSEMBLY AND ASSOCIATED METHODS OF USE

(75) Inventor: Gerald L. McFarlane, Lake Tapps, WA (US)

Correspondence Address: Thompson Hine LLP, 10 West 2nd Street, 2000 Courthouse Plaza, NE, Dayton, OH, 45402-1758, US

(73) Assignee: The Boeing Company, Irvine, CA (US)

(21) Appl. No.: 12/256,104

(22) Filed: Oct. 22, 2008

(51) Int. Cl. E06C 5/00

(52) U.S. Cl. 182/106; 182/127; 414/462

(57) ABSTRACT

A portable ladder assembly for accessing a cargo carrying structure of a transport vehicle includes a first side rail and a second side rail connected to the first side rail by steps forming a ladder structure. A stake pocket mounting structure and a bracing structure is arranged and configured to engage a sidewall of the cargo carrying structure when the stake pocket mounting structure is received by a stake pocket of the cargo carrying structure.

### FIELD

This application relates generally to ladders and, in particular, a portable ladder assembly for use in ascending and descending cargo carriers of a transport vehicle.

### BACKGROUND

A variety of trucks include trailer structures for transporting cargo. Such trailer structures often include stake pockets arranged about the periphery of the trailer structure that allow for addition and removal of stakes or sidewalls to the trailer structures. The stake pockets are fairly standard throughout the industry. Use of stakes and sidewalls are useful in retaining cargo as it is being transported.

Frequently, truck operators must climb onto and off of their truck trailers to add and remove cargo from the trailer structure. It is desirable to increase accessibility to the trailer structure.

### SUMMARY

In an aspect, a portable ladder assembly for accessing a cargo carrying structure of a transport vehicle includes a first side rail and a second side rail connected to the first side rail by steps forming a ladder structure. A stake pocket mounting structure and a bracing structure is arranged and configured to engage a sidewall of the cargo carrying structure when the stake pocket mounting structure is received by a stake pocket of the cargo carrying structure.

In another aspect, a portable ladder assembly for accessing a cargo carrying structure of a transport vehicle includes a first side rail and a second side rail connected to the first side rail by a number of steps. Each step has one end connected to the first side rail and an opposite end connected to the second side rail forming a ladder structure having a carrying structure connecting end and an opposite stepping end. A stake pocket mounting structure at the carrying structure connecting end is sized to be received within a stake pocket of the cargo carrying structure to hang the ladder structure from the cargo carrying structure. A first handle is at one side of the ladder structure and a second handle is at an opposite side of the ladder structure. The first and second handles are extendable and retractable relative to the ladder structure.

In another aspect, a method of accessing a cargo carrying structure of a transport vehicle is provided. The method includes hanging a ladder assembly from the cargo carrying structure by inserting a stake pocket mounting structure of the ladder assembly into a stake pocket of the cargo carrying structure. The ladder assembly is braced against a sidewall of the cargo carrying structure with the stake pocket mounting structure received by the stake pocket by engaging the sidewall of the cargo carrying structure with a bracing structure of the ladder assembly. The bracing structure locates a ladder structure of the ladder assembly at an angle less than vertical when the ladder structure is mounted to the cargo carrying structure.

In another aspect, a combination cargo carrying structure of a transport vehicle and removable ladder assembly is provided. The cargo carrying structure includes a number of stake pockets located at a periphery of the cargo carrying structure. The ladder assembly includes a first side rail and a second side rail connected to the first side rail by a number of steps. Each step has one end connected to the first side rail and an opposite end connected to the second side rail forming a ladder structure having a carrying structure connecting end and an opposite stepping end. A stake pocket mounting structure at the carrying structure connecting end is received within a stake pocket of the cargo carrying structure thereby hanging the ladder structure from the cargo carrying structure. A bracing structure engages with a sidewall of the cargo carrying structure with the stake pocket mounting structure received by the stake pocket. The bracing structure positions the ladder structure at an angle less than vertical with the ladder structure mounted to the cargo carrying structure.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a front view of an embodiment of a ladder assembly with handles in a storage configuration;

FIG. 2 is a side view of the ladder assembly of FIG. 1 with the handles in an extended configuration;

FIG. 3 is a side view of an embodiment of a handle for use with the ladder assembly of FIG. 1;

FIG. 4 is a detail view of an embodiment of a locking mechanism for use in locking the handles of the ladder assembly at area 4 of FIG. 1;

FIG. 5 is a side, perspective view of the ladder assembly of FIG. 1 mounted to a trailer bed of a truck;

FIG. 6 is a detail view of the ladder assembly of FIG. 5;

FIG. 7 illustrates the ladder assembly of FIG. 1 in a storage configuration and stored at a storage location;

FIG. 8 illustrates an embodiment of a method of using the ladder assembly to provide increased accessibility to a trailer bed or other cargo carrier; and

FIG. 9 is a front view of another embodiment of a ladder assembly mounted to a trailer bed.

### DETAILED DESCRIPTION

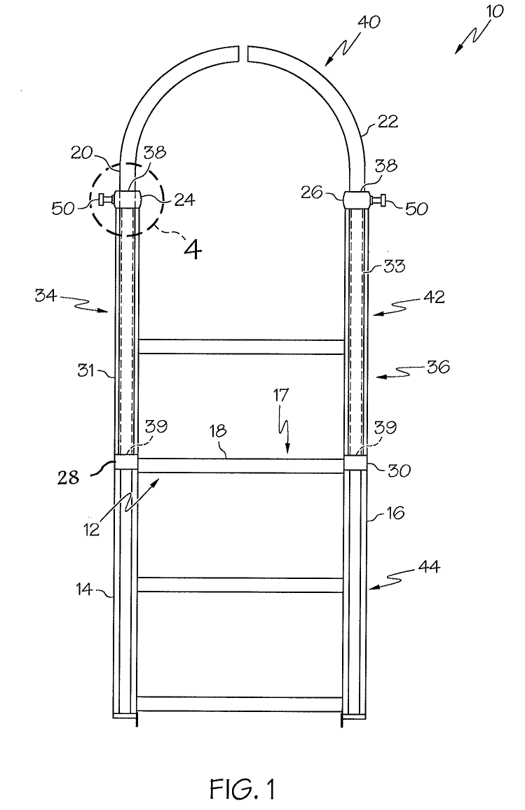

Referring to FIG. 1, a ladder assembly 10 may include a ladder structure 12 with opposite, substantially parallel side rails 14 and 16 with rungs or steps 18 extending between and connecting the side rails. The steps 18 may be arranged substantially parallel to each other and spaced-apart from one another along lengths of the side rails 14 and 16. The steps 18 may include a textured stepping surface 17 formed in the step itself (e.g., by punching) or applied to the step such as by adhering a high friction material to the surface of the step. When the ladder structure 12 is arranged vertically as shown, the steps 18 can provide support locations so that an operator can ascend and descend the ladder structure by stepping on each step.

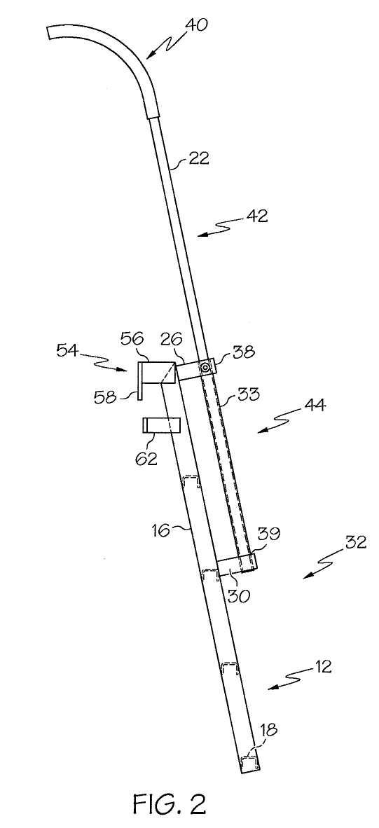

Referring also to FIG. 2, handles 20 and 22 are slidably mounted to the ladder structure 12. The handles 20 and 22 may be mounted to the ladder structure by upper mounts 24 and 26 and lower mounts 28 and 30. A hollow, open-ended tube 31 and 33 may extend between the upper mounts 24 and 26 and lower mounts 28 and 30 and slidably receives the handles 20 and 22. Upper mount 24 and lower mount 28 may be fixedly connected to and extend outwardly from side rail 14 with tube 31 fixedly mounted therebetween and upper mount 26 and lower mount 30 may be fixedly connected to and extend outwardly from side rail 16 with tube 33 fixedly mounted therebetween. While the mounts 24, 26, 28 and 30 are illustrated as extending outwardly from an operator-facing side 32 of the ladder structure 12, they could be located elsewhere such as on outer sides 34 and 36 of the side rails 14 and 16.

The upper mounts 24 and 26 include openings 38 and the lower mounts 28 and 30 include openings 39. The openings 38 and 39 may be aligned with the open ends of the tubes 31 and 33 and sized to slidably and rotatably receive the handles 20 and 22. Handles 20 and 22 may include an upper portion 40, a middle portion 42 and a lower portion 44. The upper portion 40 may have a curved shape and the middle portion 42 and lower portion 44 are substantially straight providing somewhat of an L-shaped handle. Other handle shapes are contemplated.

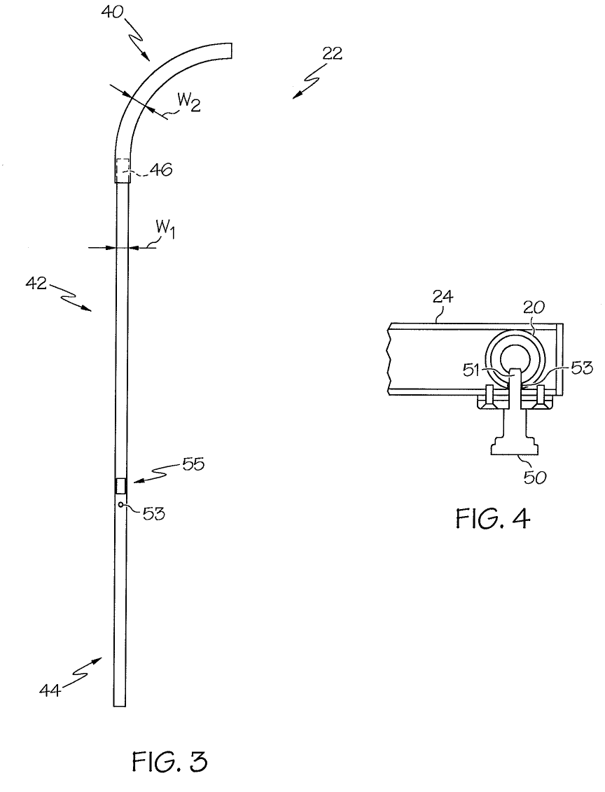

Referring briefly to FIG. 3, in the illustrated embodiment, the middle and lower portions 42 and 44 of the handles 20 and 22 have a width or diameter W₁ that is less than a width or diameter W₂ of the upper portion 40. The openings 38 in the upper mounts 24 and 26 can be sized greater than the width W₁, but less than the width W₂ so that only the middle and lower portions 42 and 44 of the handles 20 and 22 can slide within the openings 38 of the upper mounts 24 and 26. Necked-down region 46 of the handles 20 and 22 provide a stop that prevents the upper portions 40 and from sliding beyond the upper mounts 24 and 26. In another embodiment, the upper, middle and lower portions 40, 42 and 44 all have the same width or diameters.

Referring back to FIGS. 1 and 2, each handle 20 and 22 has a retracted (or storage) configuration (FIG. 1) and an extended configuration (FIG. 2). A locking mechanism 50 (FIG. 4) in the form of a pin 51 may be provided at each upper mount 24 and 26 to lock the handles 20 and 22 in their extended and retracted configurations. The pin 51 may be biased (e.g., by a spring) toward its respective handle 20 and 22 to fit within one or more pin receiving openings 53 (see also FIG. 3) disposed on a length of the handles. Visual indications 55 may be provided to highlight locking locations. Other locking mechanisms are possible, such as a friction-type locking mechanism that engages the handle, for example, through use of a threaded connection by tightening a threaded projection against the handle. Removable pin connections may also be used and affixed to the ladder structure by cords.

FIGS. 1 and 2 illustrate the ladder assembly 10 with handles 20 and 22 in different configurations. In FIG. 1, the handles 20 and 22 are illustrated with their upper portions 40 rotated inwardly (e.g., about 90 degrees from their positions in FIG. 2). Locking mechanisms 50 are used to lock the handles 20 and 22 in the positions illustrated by FIGS. 1 and 2. Rotation of the handles 20 and 22 inwardly as shown by FIG. 1 can reduce the amount of space required to store the ladder assembly 10.

As seen most clearly by FIG. 2, the ladder assembly 10 includes stake pocket mounting structures 52 and 54 (only stake pocket mounting structure 54 can be seen in FIG. 2) that are used to mount the ladder assembly to cargo carrying portion of a transport vehicle. As one example, the transport vehicle may be a truck and the cargo carrying portion may be a trailer of the truck. The stake pocket mounting structures 52 and 54 may include a ladder structure connecting member 56 connected to the side rails 14 and 16 and extending outwardly away from the operator-facing side 32 of the ladder structure. A stake pocket entry member 58 extends downwardly from the ladder structure connecting members 56 and is sized to be received within a stake pocket of the cargo carrying portion. Located below the stake pocket mounting structures 52 and 54 are bracing structures 60 and 62. As will be described in greater detail below, the bracing structures 60 and 62 engage a sidewall of the cargo carrying portion when the stake pocket mounting structures 52 and 54 are received by the stake pockets. The stake pocket mounting structures 52 and 54 and bracing structures 60 and 62 cooperate to mount the ladder structure 12 to the cargo carrying portion of the transport vehicle and to maintain a desired angle of the ladder structure at less than vertical.

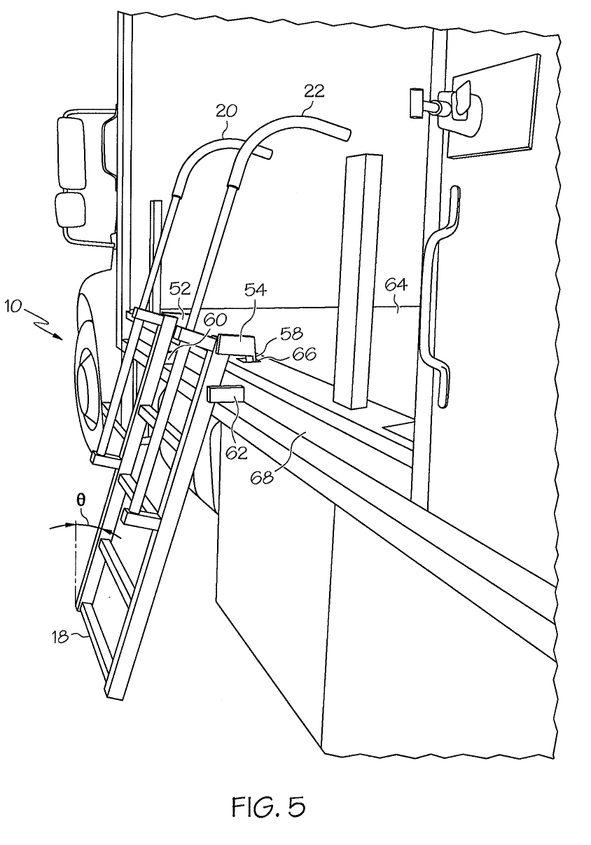

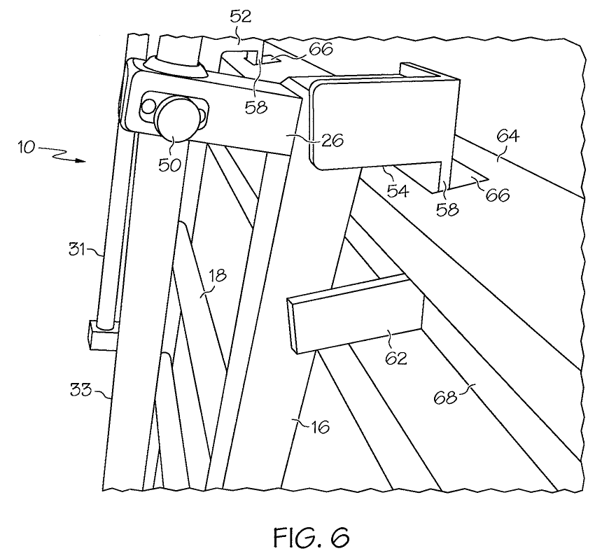

FIG. 5 illustrates the ladder assembly 10 mounted to a cargo carrying structure 64 with the handles 20 and 22 in their extended configurations. The stake pocket entry members 58 of the stake pocket mounting structures 52 and 54 are received within stake pockets 66 of the cargo carrying structure 64 with the bracing structures 60 and 62 engaged against a side wall 68 of the cargo carrying structure (see also FIG. 6). The bracing structures 60 and 62 provide a fulcrum located to cause the stake pocket entry members 58 to engage against a forward wall of the stake pockets 66 and hold the ladder assembly 10 in place.

As can be seen by FIG. 5, the bracing structures 60 and 62 position the ladder structure 12 at an angle θ less than vertical. In some embodiments, the angle θ is at least about 10 degrees, such as about 15 degrees or more. Of course, angle θ will vary depending on the location of the side wall 68 of the cargo carrying structure 64. In FIG. 5, the side wall 68 is recessed and located within a channel. In other embodiments, the side wall is not recessed.

The ladder assembly 10 may hang from the cargo carrying structure 64 at a location above the ground. In some embodiments, the ladder structure 12 is sized so that an operator does not have to bend his or her knee any more than 90 degrees to step onto the lowest step 18. The steps 18 may also be spaced apart from each other such that the operator does not have to bend his or her knees any more than 90 degrees between steps. The handles 20 and 22 are located such that the operator can grasp the handles while moving to a three point stance and then onto the ladder structure 12.

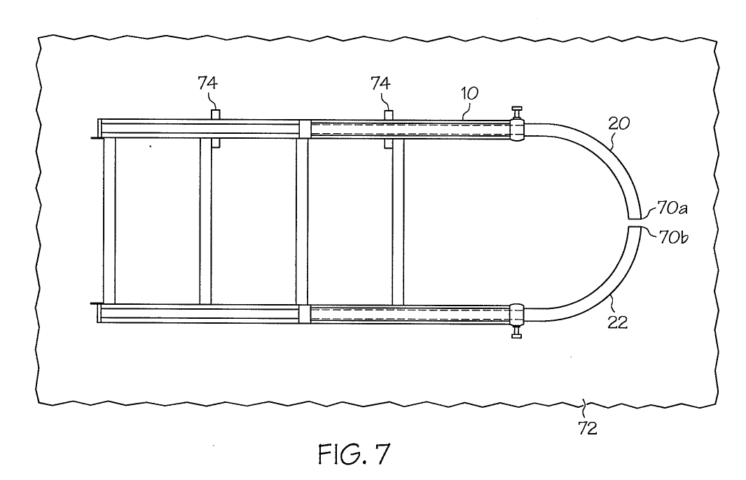

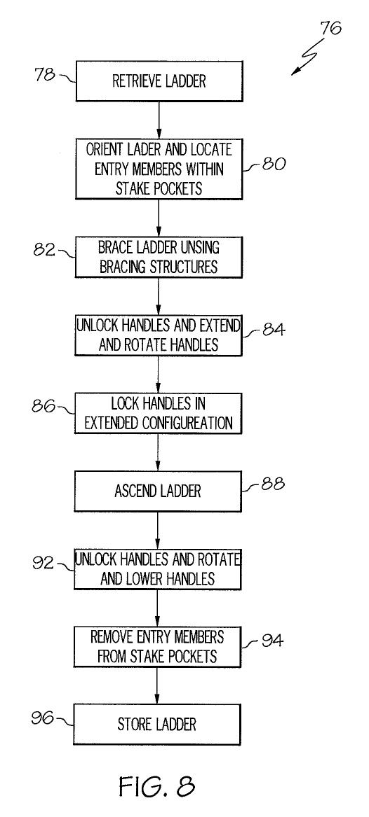

Referring to FIG. 7, the ladder assembly 10 is shown in a storage configuration with its handles 20 and 22 rotated such that ends 70a and 70b face the other handle. The ladder assembly 10 may be hung or otherwise mounted to a wall 72, for example, of the cargo carrying structure or other location on the transport vehicle. The ladder assembly 10 is hung using hanging structures 74, such as hooks, bungee cords, etc.

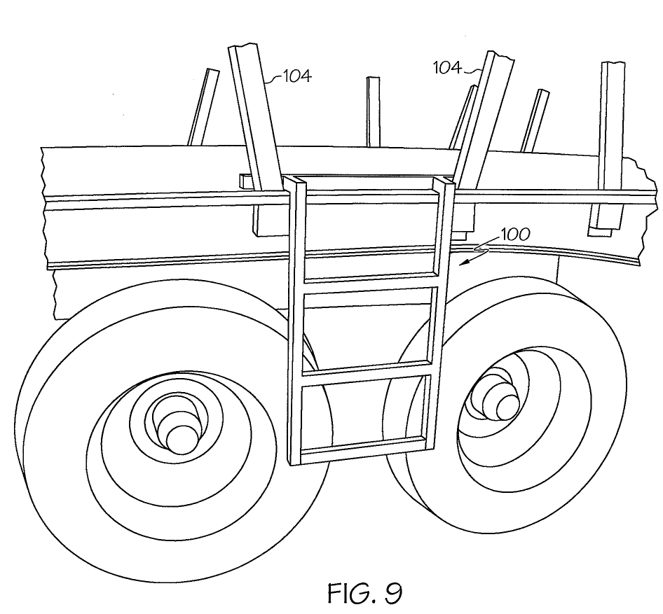

FIG. 8 illustrates a method 76 of using the ladder assembly 10 to provide increased accessibility to a cargo carrying structure. At step 78, the ladder assembly 10 is retrieved from its storage location, for example, in the cargo carrying structure, within a tool box, mounted to a cabin of the transport vehicle, etc. The ladder assembly 10 is oriented in a vertical position and the stake pocket entry members 58 are placed within the stake pockets 66 at step 80. The bracing structures 60 and 62 are then allowed to engage the side wall 68 of the cargo carrying structure 64 at step 82. At step 84, the operator unlocks the handles 20 and 22 and then places the handles in their extended configurations with the handles rotated from their storage positions. At step 86, the locking mechanisms 50 are used to lock the handles 20 and 22 in the extended configuration.

With the ladder assembly 10 mounted to the cargo carrying structure 64, the operator can ascend the ladder structure 12, pass between the handles 20 and 22 at step 88 and step onto the cargo carrying structure. The bracing structures 60 and 62 maintain the ladder structure 12 at an angles less than vertical throughout the operator's ascension on and descension from the ladder structure.

Once the operator is finished using the ladder assembly 10, the locking mechanisms 50 are released and the handles 20 and 22 are rotated and lowered into their storage positions at step 92. The stake pocket entry members 58 are removed from the stake pockets 66 at step 94 and the ladder is again stored away at the storage location at step 96.

Any suitable material may be used to form the ladder assembly 10, such as an aluminium alloy. Use of relatively light-weight materials, such as aluminum can reduce the overall weight of the ladder assembly 10. In some embodiments, the ladder assembly 10 is about 30 pounds or less, such as about 26 pounds. Welding may be used to connect various components of the ladder assembly 10. The ladder assembly 10 can include various other features such as florescent steps, warnings, instructions for use, a grip or wrap about the handles, etc.

The above-described ladder assembly 10 may include a number of advantages and provides a relatively lightweight, portable ladder structure for increasing accessibility to a cargo carrying structure. The ladder assembly 10, once mounted to the cargo carrying structure, such as a trailer bed, may be located at an angle to the vertical, which can improve the ability of the operator to ascend and descend the ladder structure 12 and increase the visibility of the steps 18. Handles 20 and 22 may be provided that have both extended and retracted configurations. The handles 20 and 22 may also rotate relative to the ladder structure 12 to place the handles in their storage configurations. The handles 20 and 22 may slide within tubes 31 and 33 that are fixedly mounted to the ladder structure 12. The tubes 31 and 33 can provide a fixed grasping location for the operator, for example, when the operator carries the ladder assembly from one location to another. Because size and location of stake pockets are relatively standard, the ladder assembly 10 can be used on a variety of cargo carrying structures including the stake pockets.

It is to be clearly understood that the above description is intended by way of illustration and example only and is not intended to be taken by way of limitation, and that changes and modifications are possible. For example, FIG. 9 illustrates an alternative ladder assembly 100 that includes stake engaging structure 102 that engages stakes 104 located in stake pockets and hangs therefrom. Accordingly, other embodiments are contemplated and modifications and changes could be made without departing from the scope of this application.

What is claimed is:

1-23. (canceled)

24. A portable ladder assembly for accessing a cargo carrying structure of a transport vehicle, the cargo carrying structure including stakes, the ladder assembly comprising:
a first side rail;
a second side rail connected to the first side rail by a plurality of steps, each step of the plurality having a first end connected to the first side rail and a second, opposite end connected to the second side rail, thereby forming a ladder structure having a carrying structure connecting end and an opposite stepping end; and
a stake engaging structure disposed proximate the carrying structure connecting end, the stake engaging structure being sized and shaped to engage the stakes of the cargo carrying structure to hang the ladder structure from the cargo carrying structure.

25. The portable ladder assembly of claim 24 wherein the ladder structure is at an angle less than vertical when the ladder structure is connected to the cargo carrying structure.

26. The portable ladder assembly of claim 24 wherein the ladder structure is shorter than a height of the cargo carrying structure from the ground such that the stepping end hangs above the ground when the ladder structure is mounted to the cargo carrying structure.
